(19) United States
(12) Patent Application Publication
(10) Pub. No.: US 2002/0172352 A1
(43) Pub. Date: Nov. 21, 2002

(54) Non-embedded acoustic echo cancellation

(76) Inventor: Ofir Mecayten, Netanya (IL)

Correspondence Address: KATTEN MUCHIN ZAVIS ROSENMAN, 575 MADISON AVENUE, NEW YORK, NY, 10022-2585, US

(21) Appl. No.: 09/858,626

(22) Filed: May 16, 2001

(51) Int. Cl. H04M 9/08

(52) U.S. Cl. 379/406.01

(57) ABSTRACT

An acoustic echo cancellation system including a record queue operative to receive at least one audio input unit, a playback queue operative to receive at least one audio output unit, an acoustic echo canceller, and synchronization control apparatus operative to retrieve the audio input unit form the record queue and the audio output unit from the playback queue, and simultaneously provide the retrieved units to the acoustic echo canceller for acoustic echo cancellation thereat.

### FIELD OF INVENTION

The present invention relates to voice communications systems in general, and more particularly to acoustic echo cancellation in computer network telephony systems.

### BACKGROUND OF THE INVENTION

One well-known type of echo in voice communications systems, acoustic echo, is caused by acoustic coupling between the microphone and speaker of a telephone or network telephony enabled personal computer (PC), where speaker output is received by the microphone as input and retransmitted back to the transmission source. Known acoustic echo cancellation techniques detect acoustic echo and subtract it from the microphone input at an acoustic echo canceller (AEC). ABCs typically require the speaker output signal and the microphone input signal to be input in a time-synchronized fashion, with the acoustic echo signature offset from the speaker output signal by a time delay due to the time required for the speaker output to travel to the microphone. The AEC adjusts for the time delay and subtracts the echo from the input signal. The AEC can also adjust for minor shifts in the time delay due to minor changes in the acoustic environment, such as when the position of the microphone changes relative to the position of the speaker.

AECs are typically implemented as embedded systems built specifically to provide acoustic echo cancellation, employing dedicated hardware, such as digital signal processors (DSP), and a real-time operating system (RTOS). While a PC processor and operating system may be used to provide acoustic echo cancellation, PCs are typically designed for multitasking, non-real-time applications, with multiple applications concurrently vying for shared resources, and are thus ill-suited to provide the time-synchronized inputs required by an AEC. A PC's speakers and microphone are both connected to the PC's sound card, yet they typically operate independently. In order to ensure audio output that is as continuous as possible, the playback thread that feeds the speakers receives very high priority from the operating system. In contrast, continuous recording cannot typically be achieved as recording receives a much lower priority from the operating system, and this cannot usually be controlled at the application level. Such disparity often results in the speaker's output stream being received by the AEC more frequently and regularly than the microphone's input buffer, resulting in non-time-synchronized input to the AEC, as well as lost input due to buffer overflow. While ABCs are generally configured to buffer the speaker's output stream and the microphone's input buffer until they have a sufficient portion of each in order to perform the time delay adjustment and echo subtraction, lost input in one stream relative to the other causes relatively large shifts in the time delay to which AECs adapt poorly.

### SUMMARY OF THE INVENTION

The present invention seeks to provide non-embedded acoustic echo cancellation for use in computer network telephony systems whereby lost input in the record stream relative to the playback stream, and vice versa, is compensated for prior to performing acoustic echo cancellation. The present invention thus avoids relatively large shifts in the time delay between record and playback streams without requiring modification at the AEC.

There is thus provided in accordance with a preferred embodiment of the present invention an acoustic echo cancellation system including a record queue operative to receive at least one audio input unit, a playback queue operative to receive at least one audio output unit an acoustic echo canceller, and synchronization control apparatus operative to retrieve the audio input unit from the record queue and the audio output unit from the playback queue, and simultaneously provide the retrieved units to the acoustic echo canceller for acoustic echo cancellation thereat.

Further in accordance with a preferred embodiment of the present invention the synchronization control apparatus is operative to perform the retrieval and the simultaneous provision in response to the playback queue receiving the audio output unit.

Still further in accordance with a preferred embodiment of the present invention the synchronization control apparatus is operative to perform the retrieval and the simultaneous provision in response to the playback queue receiving the audio output unit provided the record queue is non-empty.

Additionally in accordance with a preferred embodiment of the present invention the system further includes an audio output unit counter, and the synchronization control apparatus is additionally operative in response to the playback queue receiving the audio output unit to increment the audio output unit counter, and decrement the audio output unit counter when the audio output unit is retrieved from the playback queue.

Moreover in accordance with a preferred embodiment of the present invention the synchronization control apparatus is additionally operative upon the record queue becoming empty to compare the current minimum value of the counter with at least one previous minimum value of the counter when the record queue previously became empty, and if the current minimum value is greater than the previous minimum value, erase at least one of the audio output units from the playback queue.

Further in accordance with a preferred embodiment of the present invention the synchronization control apparatus erases a number of the audio output units from the playback queue not exceeding the difference between the current minimum value and the previous minimum value.

Still further in accordance with a preferred embodiment of the present invention the synchronization control apparatus is operative to decrement the counter by the number of the audio output units erased from the playback queue.

Additionally in accordance with a preferred embodiment of the present invention the synchronization control apparatus is operative to set a new previous minimum value equal to the current minimum value.

Moreover in accordance with a preferred embodiment of the present invention the synchronization control apparatus is additionally operative upon the record queue becoming empty to compare a series of current minimum values of the counter with at least one previous minimum value of the counter when the record queue previously became empty, and if each of the current minimum values is greater than the previous minimum value, erase at least one of the audio output units from the playback queue.

Further in accordance with a preferred embodiment of the present invention the synchronization control apparatus erases a number of the audio output units from the playback queue not exceeding the difference between the lesser of the current minimum values and the previous minimum value.

Still further in accordance with a preferred embodiment of the present invention the synchronization control apparatus is operative to decrement the counter by the number of the audio output units erased from the playback queue.

Additionally in accordance with a preferred embodiment of the present invention the synchronization control apparatus is operative to set a new previous minimum value equal to the lesser of the current minimum values.

Moreover in accordance with a preferred embodiment of the present invention the synchronization control apparatus is operative upon the playback queue becoming empty and the record queue being non-empty to erase at least one of the audio input units from the record queue.

Further in accordance with a preferred embodiment of the present invention the synchronization control apparatus erases all of the audio input units from the record queue.

Still further in accordance with a preferred embodiment of the present invention the synchronization control apparatus erases provided the playback queue is empty on a plurality of occasions.

Additionally in accordance with a preferred embodiment of the present invention the synchronization control apparatus erases provided the playback queue is empty for a predefined period of time.

There is also provided in accordance with a preferred embodiment of the present invention a method of acoustic echo cancellation including receiving at least one audio input unit at a record queue, receiving at least one audio output unit at a playback queue, retrieving the audio input unit from the record queue and the audio output unit from the playback queue, and simultaneously providing the retrieved units to an acoustic echo canceller for acoustic echo cancellation thereat.

Further in accordance with a preferred embodiment of the present invention the simultaneously providing step includes simultaneously providing in response to the playback queue receiving the audio output unit.

Still further in accordance with a preferred embodiment of the present invention the simultaneously providing step includes simultaneously providing in response to the playback queue receiving the audio output unit provided the record queue is non-empty.

Additionally in accordance with a preferred embodiment of the present invention the method further includes incrementing an audio output unit counter in response to the playback queue receiving the audio output unit, and decrementing the audio output unit counter when the audio output unit is retrieved from the playback queue.

Moreover in accordance with a preferred embodiment of the present invention the method further includes comparing, upon the record queue becoming empty, the current minimum value of the counter with at least one previous minimum value of the counter when the record queue previously became empty, and erasing, if the current minimum value is greater than the previous minimum value, at least one of the audio output units from the playback queue.

Further in accordance with a preferred embodiment of the present invention the erasing step includes erasing a number of the audio output units from the playback queue not exceeding the difference between the current minimum value and the previous minimum value.

Still further in accordance with a preferred embodiment of the present invention the method further includes decrementing the counter by the number of the audio output units erased from the playback queue.

Additionally in accordance with a preferred embodiment of the present invention the method further includes setting a new previous minimum value equal to the current minimum value.

Moreover in accordance with a preferred embodiment of the present invention the synchronization control apparatus is additionally operative upon the record queue becoming empty to comparing, upon the record queue becoming empty, a series of current minimum values of the counter with at least one previous minimum value of the counter when the record queue previously became empty, and erasing, if each of the current minimum value is greater than the previous minimum value, at least one of the audio output units from the playback queue.

Further in accordance with a preferred embodiment of the present invention the erasing step includes erasing a number of the audio output units from the playback queue not exceeding the difference between the lesser of the current minimum values and the previous minimum value.

Still further in accordance with a preferred embodiment of the present invention the method further includes decrementing the counter by the number of the audio output units erased from the playback queue.

Additionally in accordance with a preferred embodiment of the present invention the method further includes setting a new previous minimum value equal to the lesser of the current minimum values.

Moreover in accordance with a preferred embodiment of the present invention the method further includes erasing at least one of the audio input units from the record queue upon the playback queue becoming empty and the record queue being non-empty.

Further in accordance with a preferred embodiment of the present invention the erasing step includes erasing all of the audio input units from the record queue.

Still further in accordance with a preferred embodiment of the present invention the erasing step includes erasing provided the playback queue is empty on a plurality of occasions.

Additionally in accordance with a preferred embodiment of the present invention the erasing step includes erasing provided the playback queue is empty for a predefined period of time.

Moreover in accordance with a preferred embodiment of the present invention the method further includes at the first instance where at least one audio input unit is detected in the record queue and at least one audio output unit is detected in the playback queue, if there is a difference between the number of the units in each of the queues, removing at least one of the units from either of the queues until both of the queues have the same number of the units.

Further in accordance with a preferred embodiment of the present invention the removing step includes removing if the difference between the number of the units in each of the queues exceeds a predefined threshold.

Still further in accordance with a preferred embodiment of the present invention the method further includes at the first instance where at least one audio input unit is detected in the record queue and at least one audio output unit is detected in the playback queue, if there is a difference between the number of the units in each of the queues, removing at least one of the units from either of the queues until the difference between the number of the units in each of the queues does not exceed a predefined threshold.

Additionally in accordance with a preferred embodiment of the present invention the removing step includes removing if the difference between the number of the units in each of the queues exceeds a predefined threshold.

Moreover in accordance with a preferred embodiment of the present invention the synchronization control apparatus is operative to perform the retrieval and the simultaneous provision in response to the record queue receiving the audio input unit.

Further in accordance with a preferred embodiment of the present invention the synchronization control apparatus is operative to perform the retrieval and the simultaneous provision in response to the record queue receiving the audio input unit provided the playback queue is non-empty.

Still further in accordance with a preferred embodiment of the present invention the system further includes an audio input unit counter, and the synchronization control apparatus is additionally operative in response to the record queue receiving the audio input unit to increment the audio input unit counter, and decrement the audio input unit counter when the audio input unit is retrieved from the record queue.

Additionally in accordance with a preferred embodiment of the present invention the synchronization control apparatus is additionally operative upon the playback queue becoming empty to compare the current minimum value of the counter with at least one previous minimum value of the counter when the playback queue previously became empty, and if the current minimum value is greater than the previous minimum value, erase at least one of the audio input units from the record queue.

Moreover in accordance with a preferred embodiment of the present invention the synchronization control apparatus erases a number of the audio input units from the record queue not exceeding the difference between the current minimum value and the previous minimum value.

Further in accordance with a preferred embodiment of the present invention the synchronization control apparatus is operative to decrement the counter by the number of the audio input units erased from the record queue.

Still further in accordance with a preferred embodiment of the present invention the synchronization control apparatus is operative to set a new previous minimum value equal to the current minimum value.

Additionally in accordance with a preferred embodiment of the present invention the synchronization control apparatus is additionally operative upon the playback queue becoming empty to compare a series of current minimum values of the counter with at least one previous minimum value of the counter when the playback queue previously became empty, and if each of the current minimum values is greater than the previous minimum value, erase at least one of the audio input units from the record queue.

Moreover in accordance with a preferred embodiment of the present invention the synchronization control apparatus erases a number of the audio input units from the record queue not exceeding the difference between the lesser of the current minimum values and the previous minimum value.

Further in accordance with a preferred embodiment of the present invention the synchronization control apparatus is operative to decrement the counter by the number of the audio input units erased from the record queue.

Still further in accordance with a preferred embodiment of the present invention the synchronization control apparatus is operative to set a new previous minimum value equal to the lesser of the current minimum values.

Additionally in accordance with a preferred embodiment of the present invention the synchronization control apparatus is operative upon the record queue becoming empty and the playback queue being non-empty to erase at least one of the audio output units from the playback queue.

Moreover in accordance with a preferred embodiment of the present invention the synchronization control apparatus erases all of the audio output units from the playback queue.

Further in accordance with a preferred embodiment of the present invention the synchronization control apparatus erases provided the record queue is empty on a plurality of occasions.

Still further in accordance with a preferred embodiment of the present invention the synchronization control apparatus erases provided the record queue is empty for a predefined period of time.

Additionally in accordance with a preferred embodiment of the present invention the simultaneously providing step includes simultaneously providing in response to the record queue receiving the audio input unit.

Moreover in accordance with a preferred embodiment of the present invention the simultaneously providing step includes simultaneously providing in response to the record queue receiving the audio input unit provided the playback queue is non-empty.

Further in accordance with a preferred embodiment of the present invention the method further includes incrementing an audio input unit counter in response to the record queue receiving the audio input unit, and decrementing the audio input unit counter when the audio input unit is retrieved from the record queue.

Still further in accordance with a preferred embodiment of the present invention the method further includes comparing, upon the playback queue becoming empty, the current minimum value of the counter with at least one previous minimum value of the counter when the playback queue previously became empty, and erasing, if the current minimum value is greater than the previous minimum value, at least one of the audio input units from the record queue.

Additionally in accordance with a preferred embodiment of the present invention the erasing step includes erasing a number of the audio input units from the record queue not exceeding the difference between the current minimum value and the previous minimum value.

Moreover in accordance with a preferred embodiment of the present invention the method further includes decrementing the counter by the number of the audio input units erased from the record queue.

Further in accordance with a preferred embodiment of the present invention the method further includes setting a new previous minimum value equal to the current minimum value.

Still further in accordance with a preferred embodiment of the present invention the synchronization control apparatus is additionally operative upon the playback queue becoming empty to comparing, upon the playback queue becoming empty, a series of current minimum values of the counter with at least one previous minimum value of the counter when the playback queue previously became empty, and erasing, if each of the current minimum value is greater than the previous minimum value, at least one of the audio input units from the record queue.

Additionally in accordance with a preferred embodiment of the present invention the erasing step includes erasing a number of the audio input units from the record queue not exceeding the difference between the lesser of the current minimum values and the previous minimum value.

Moreover in accordance with a preferred embodiment of the present invention the method ether includes decrementing the counter by the number of the audio input units erased from the record queue.

Further in accordance with a preferred embodiment of the present invention the method further includes setting a new previous minimum value equal to the lesser of the current minimum values.

Still further in accordance with a preferred embodiment of the present invention the method further includes erasing at least one of the audio output units from the playback queue upon the record queue becoming empty and the playback queue being non-empty.

Additionally in accordance with a preferred embodiment of the present invention the erasing step includes erasing all of the audio output units from the playback queue.

Moreover in accordance with a preferred embodiment of the present invention the erasing step includes erasing provided the record queue is empty on a plurality of occasions.

Further in accordance with a preferred embodiment of the present invention the erasing step includes erasing provided the record queue is empty for a predefined period of time.

Still further in accordance with a preferred embodiment of the present invention the method further includes at the first instance where at least one audio output unit is detected in the playback queue and at least one audio input unit is detected in the record queue, if there is a difference between the number of the units in each of the queues, removing at least one of the units from either of the queues until both of the queues have the same number of the units.

Additionally in accordance with a preferred embodiment of the present invention the removing step includes removing if the difference between the number of the units in each of the queues exceeds a predefined threshold.

Moreover in accordance with a preferred embodiment of the present invention the method further includes at the first instance where at least one audio output unit is detected in the playback queue and at least one audio input unit is detected in the record queue, if there is a difference between the number of the units in each of the queues, removing at least one of the units from either of the queues until the difference between the number of the units in each of the queues does not exceed a predefined threshold.

Further in accordance with a preferred embodiment of the present invention the removing step includes removing if the difference between the number of the units in each of the queues exceeds a predefined threshold.

The disclosures of all patents, patent applications, and other publications mentioned in this specification and of the patents, patent applications, and other publications cited therein are hereby incorporated by reference.

### BRIEF DESCRIPTION OF THE DRAWINGS

The present invention will be understood and appreciated more fully from the following detailed description taken in conjunction with the appended drawings in which:

FIG. 1 is a simplified block diagram of an acoustic echo cancellation system, constructed and operative in accordance with a preferred embodiment of the present invention;

FIGS. 2A, 2B, 2C, and 2D, taken together, are a simplified flowchart illusion of a method of operation of the system of FIG. 1 at steady state, operative in accordance with a preferred embodiment of the present invention;

FIG. 3 is a simplified flowchart illustration of an exemplary method of initializing the system of FIG. 1, operative in accordance with a preferred embodiment of the present invention;

FIG. 4 is a simplified block diagram of an acoustic echo cancellation system, constructed and operative in accordance with a preferred embodiment of the present invention; and

FIGS. 5A, 5B, 5C, and 5D, taken together, are a simplified flowchart illustration of a method of operation of the system of FIG. 4 at steady state, operative in accordance with a preferred embodiment of the present invention.

### DETAILED DESCRIPTION OF PREFERRED EMBODIMENTS

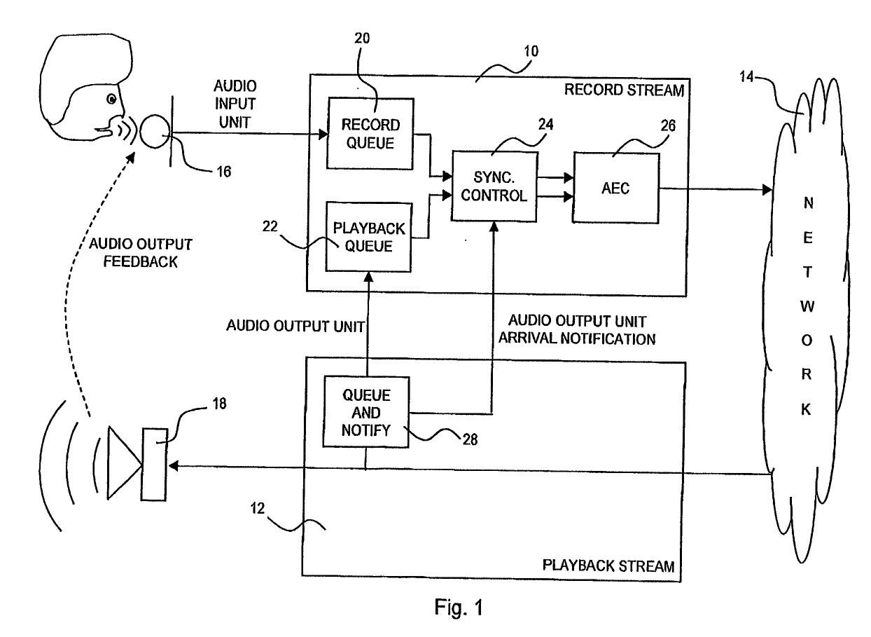

Reference is now made to FIG. 1, which is a simplified block diagram of an acoustic echo cancellation system, constructed and operative in accordance with a preferred embodiment of the present invention. A record stream 10 and a playback stream 12 are shown in communication with a network 14, such as the Internet. Record stream 10 and playback stream 12 may be implemented concurrently as separate sub-applications within the context of a single voice-over-internet-protocol (VoIP) software client using conventional techniques on a personal computer having a multitasking operating system, such as Microsoft Windows 2000™.

Record stream 10 receives audio input units from an audio input device 16, such as microphone connected to a sound card, typically in the form of audio packets or frames of a set configuration, such as 320-byte units representing 20 ms of audio sampling at an 8 KHz sampling rate with 16 bits per sample. Playback stream 12 receives audio output units from network 14 which are typically identical in configuration to the audio input units with respect to sampling and duration. Playback stream 12 forwards audio output units received from network 14 for output at an audio output device 18, such as a speaker connected to a sound card, using conventional techniques.

Record stream 10 includes a record queue 20, into which audio input units received from audio input device 16 are queued, a playback queue 22, into which audio output units received from playback stream 12 are queued, and synchronization apparatus 24, which retrieves audio input units from record queue 20 and audio output units from playback queue 22, and provides them to an acoustic echo canceller 26, which performs acoustic echo cancellation using any conventional technique.

Playback stream 12 also includes queuing and notification apparatus 28 which provides audio output units received from network 14 to playback queue 22, and notifies synchronization apparatus 24 of the arrival of each audio output unit at playback queue 22.

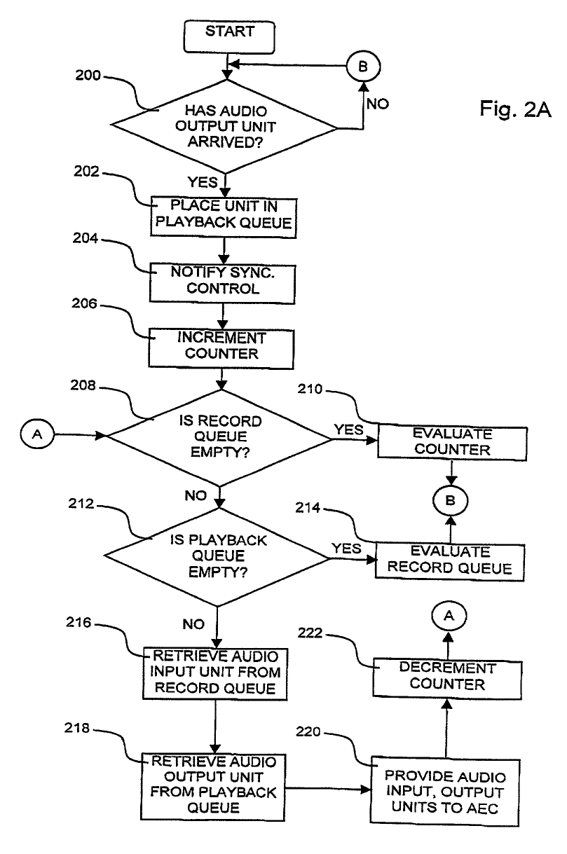

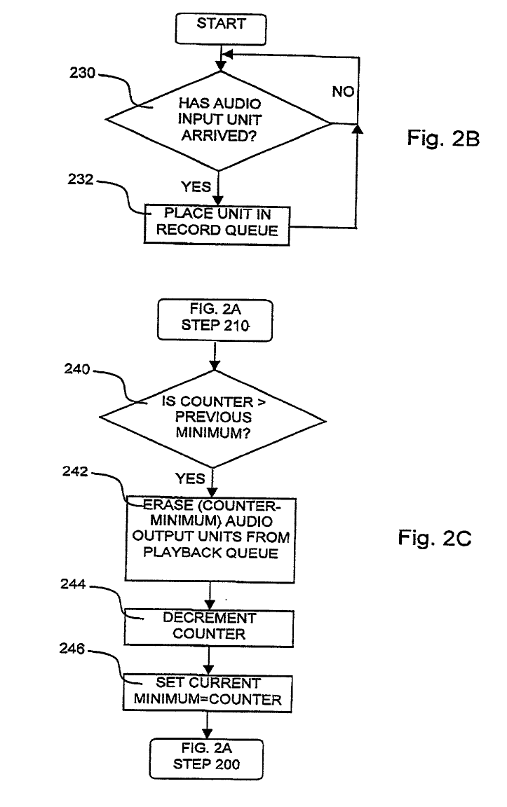

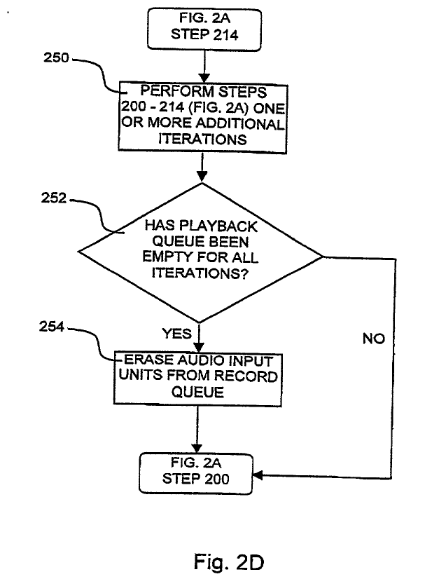

Reference is now made to FIGS. 2A, 2B, 2C, and 2D, which, taken together, are a simplified flowchart illustration of an exemplary method of operation of the system of FIG. 1 at steady state, operative in accordance with a preferred embodiment of the present invention. Referring particularly to the method of FIG. 2A, as each audio output unit arrives at playback stream 12 from network 14 (step 200) queuing and notification apparatus 28 places a copy of the audio output unit into playback queue 22 (step 202) and notifies synchronization apparatus 24 of the arrival of the output unit at playback queue 22 (step 204). A counter, typically maintained within the context of record stream 10, is then incremented by synchronization apparatus 24 to reflect the addition of one more audio output unit to playback queue 22 (step 206), Synchronization apparatus 24 then checks record queue 20 for the presence of any previously queued audio input units (step 208). If record queue 20 is empty, then the counter is evaluated in the manner described in greater detail hereinbelow with reference to FIG. 2C (step 210). If record queue 20 is non-empty, synchronization apparatus 24 checks playback queue 22 for the presence of any previously queued audio output units (step 212). If playback queue 22 is empty, then record queue 20 is evaluated in the manner described in greater detail hereinbelow with reference to FIG. 2D (step 214).

Once it is determined that both record queue 20 and playback queue 22 are non-empty, synchronization apparatus 24 retrieves one audio input unit from record queue 20 (step 216) and one audio output unit from playback queue 22 (step 218) and provides them to acoustic echo canceller 26 for echo cancellation thereat in accordance with conventional techniques (step 220). The counter is then decremented by synchronization apparatus 24 to reflect the removal of the audio output unit from playback queue 22 (step 222), and processing continues with step 208.

Referring now to the method of FIG. 2B, as each audio input unit arrives at record stream 10 (step 230) it is placed in record queue 20 (step 232).

Referring now to the method of FIG. 2C, which describes in greater detail a method for carrying out step 210 above, when record queue 20 becomes empty, the value of the counter referred to in step 206 above is said to reach a “minimum” value. The current minimum counter value is then compared with the previous minimum value the counter had when record queue 20 last became empty (step 240). If the current counter minimum is greater than the counter's previous minimum value, then one or more audio output units are erased from playback queue 22 to the extent of the difference between the current minimum and the previous minimum (i.e., (current counter−previous minimum) audio output units are removed) (step 242). The counter is then decremented by the number of audio output units erased from playback queue 22 (step 244), and then current minimum is set equal to the counter (step 246). Alternatively, the counter is not decremented, and a new minimum is set according to the current minimum. Processing may then continue with step 200 (FIG. 2A).

Step 240 may be modified such that once it is detected that the current minimum is greater than the previous minimum, then one or more subsequent minimum counter values may be evaluated, and steps 242-246 may be performed only if the series of minimum counter values are all higher than the previous minimum, with the lesser of the series of minimum counter values used as the current minimum. Should any minimum in the series return to the previous minimum, or dip below the previous minimum, then steps 242-246 are not performed.

Referring now to the method of FIG. 2D, which describes in greater detail a preferred method for carrying out step 214 above, when it is detected that playback queue 22 is empty while record queue 20 is non-empty, steps 200-214 (FIG. 2A) may be performed for a predefined number of additional iterations or for a predefined period of time (step 250). If playback queue 22 is empty while record queue 20 is non-empty after a predefined number of iterations, or for a predefined period of time, (step 252), then one or more, and preferably all, of the audio input units are erased from record queue 20 (step 254), and processing may continue with step 200 (FIG. 2A).

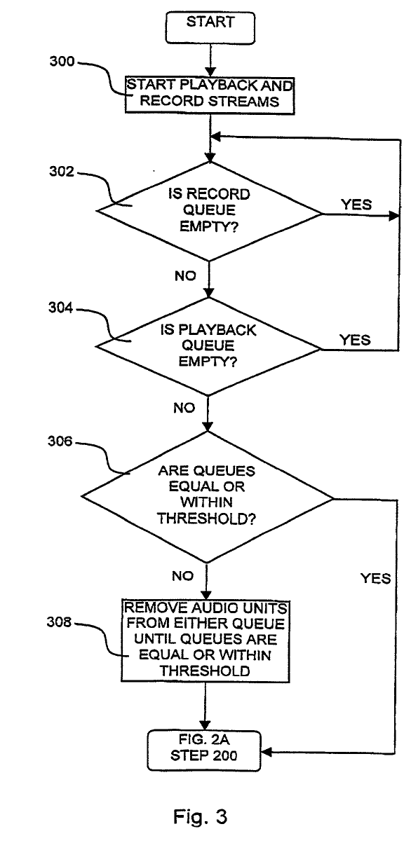

Reference is now made to FIG. 3, which is a simplified flowchart illustration of an exemplary method of initializing the system of FIG. 1, operative in accordance with a preferred embodiment of the present invention. In the method of FIG. 3, record stream 10 and playback stream 12 are instructed to begin placing audio input units into record queue 20 and audio output units into playback queue 22 respectively (step 300). At the first instance where at least one audio input unit is detected in record queue 20 (step 302) and at least one audio output unit is detected in playback queue 22 (step 304), if there is a difference between the number of units in each queue, or if the difference between the number of units in each queue exceeds a predefined threshold (step 306), then one or more units may be removed from one or both queues, either until both queues have the same number of units or until the difference between the number of units in each queue does not exceed the predefined threshold (step 308), and processing may continue with step 200 (FIG. 2A).

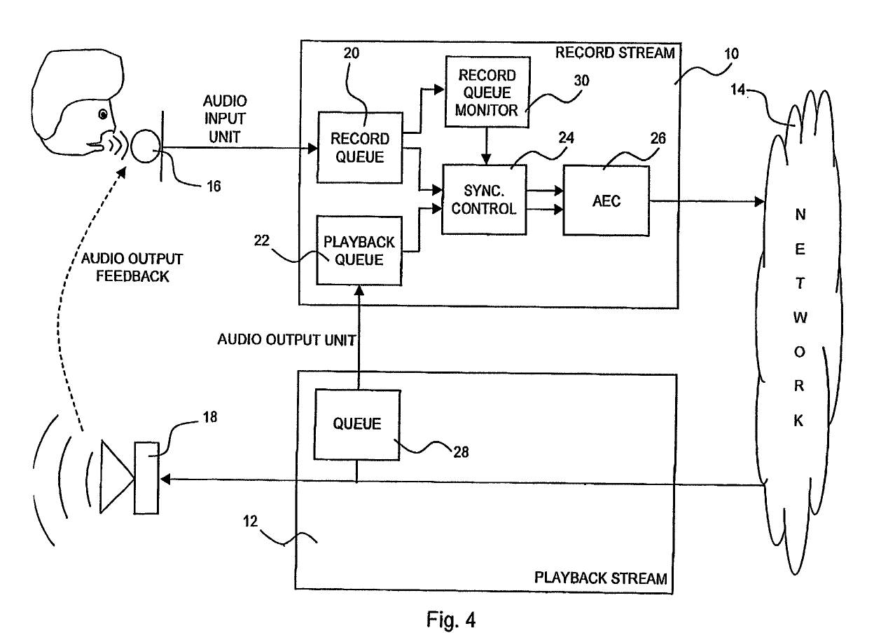

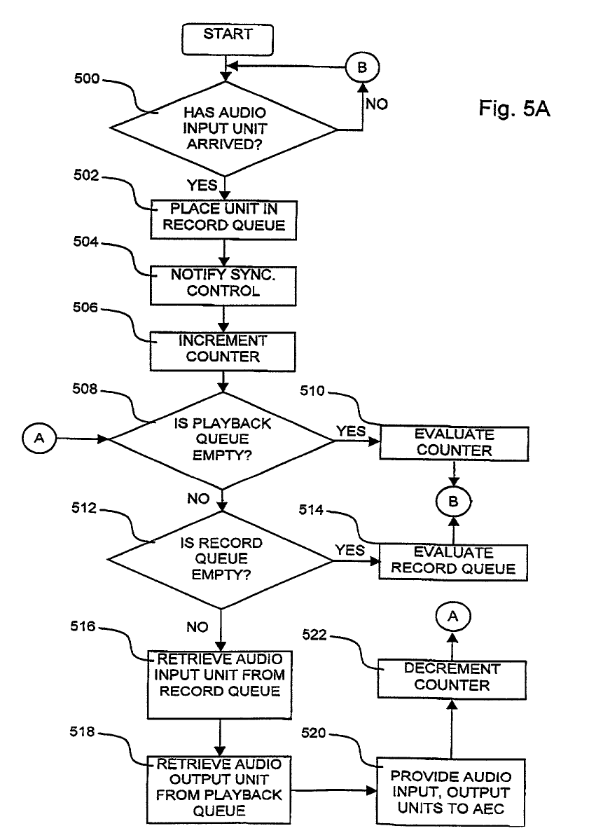

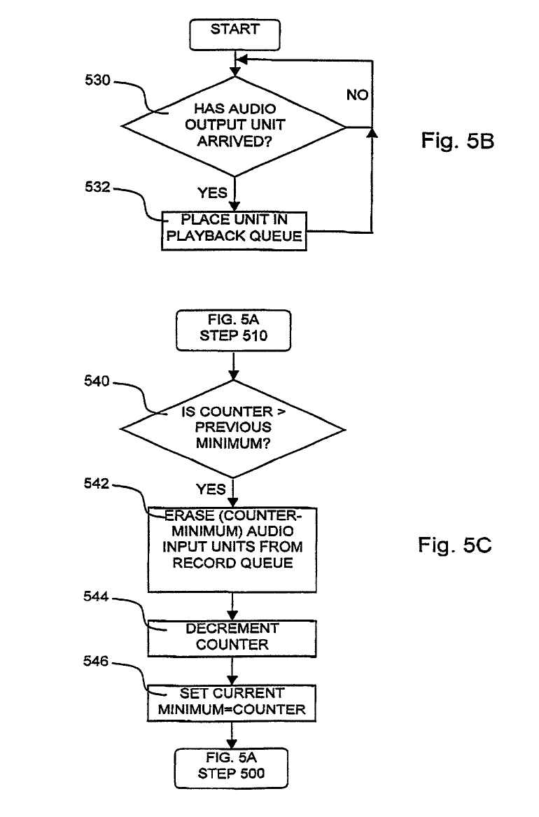

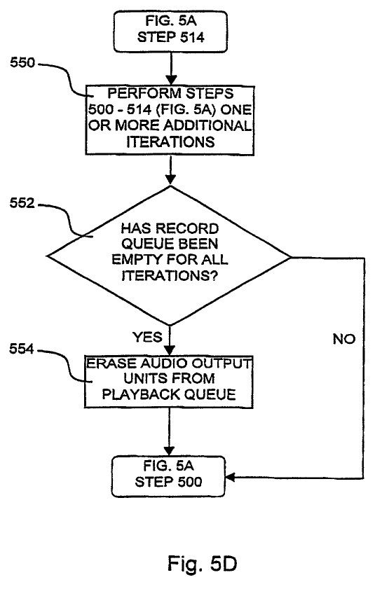

Reference is now made to FIG. 4, which is a simplified block diagram of an acoustic echo cancellation system, constructed and operative in accordance with a preferred embodiment of the present invention, and additionally to FIGS. 5A, 5B, 5C, and 5D, which, taken together, are a simplified flowchart illustration of an exemplary method of operation of the system of FIG. 4 at steady state, operative in accordance with a preferred embodiment of the present invention. It is appreciated that the system of FIG. 1 and the methods of FIGS. 2A, 2B, 2C, 2D, and 3 may be implemented such that, instead of maintaining a counter to reflect the number of audio output units in playback queue 22, a counter is maintained to reflect the number of audio input units in record queue 20. In this embodiment, shown in FIG. 4, record queue monitoring apparatus 30 is provided, typically being implemented within the context of record stream 10, and is responsible for placing audio input units into record queue 20, or detecting the arrival of audio input units into record queue 20, and notifying synchronization apparatus 24 to increment the audio input unit counter. The methods of FIGS. 5A, 5B, 5C, and 5D, therefore, apply these principles to the methods of FIGS. 2A, 2B, 2C, and 2D, where references to record queue 20 and playback queue 22 are switched, and references to audio input units and audio output units are switched. Likewise, the method of FIG. 3 may be applied to the system of FIG. 4 and the methods of FIGS. 5A, 5B, 5C, 5D, with processing continuing after step 308 (FIG. 3) with step 500 (FIG. 5A).

It is appreciated that one or more steps of any of the methods described herein may be implemented in a different order than that shown while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. An acoustic echo cancellation system comprising:
a record queue operative to receive at least one audio input unit;
a playback queue operative to receive at least one audio output unit;
an acoustic echo canceller; and
synchronization control apparatus operative to:
retrieve said audio input unit from said record queue and said audio output unit from said playback queue, and
simultaneously provide said retrieved units to said acoustic echo canceller for acoustic echo cancellation thereat.

2. A system according to claim 1 wherein said synchronization control apparatus is operative to perform said retrieval and said simultaneous provision in response to said playback queue receiving said audio output unit.

3. A system according to claim 1 wherein said synchronization control apparatus is operative to perform said retrieval and said simultaneous provision in response to said playback queue receiving said audio output unit provided said record queue is non-empty.

4. A system according to claim 1 and further comprising:
an audio output unit counter,
and wherein said synchronization control apparatus is additionally operative in response to said playback queue receiving said audio output unit to:
increment said audio output unit counter, and
decrement said audio output unit counter when said audio output unit is retrieved from said playback queue.

5. A system according to claim 4 wherein said synchronization control apparatus is additionally operative upon said record queue becoming empty to:
compare the current minimum value of said counter with at least one previous minimum value of said counter when said record queue previously became empty, and
if said current minimum value is greater than said previous minimum value, erase at least one of said audio output units from said playback queue.

6. A system according to claim 5 wherein said synchronization control apparatus erases a number of said audio output units from said playback queue not exceeding the difference between said current minimum value and said previous minimum value.

7. A system according to claim 5 wherein said synchronization control apparatus is operative to decrement said counter by the number of said audio output units erased from said playback queue.

8. A system according to claim 5 wherein said synchronization control apparatus is operative to set a new previous minimum value equal to said current minimum value.

9. A system according to claim 4 wherein said synchronization control apparatus is additionally operative upon said record queue becoming empty to:
compare a series of current minimum values of said counter with at least one previous minimum value of said counter when said record queue previously became empty, and
if each of said current minimum values is greater than said previous minimum value, erase at least one of said audio output units from said playback queue.

10. A system according to claim 9 wherein said synchronization control apparatus erases a number of said audio output units from said playback queue not exceeding the difference between the lesser of said current minimum values and said previous minimum value.

11. A system according to claim 9 wherein said synchronization control apparatus is operative to decrement said counter by the number of said audio output units erased from said playback queue.

12. A system according to claim 9 wherein said synchronization control apparatus is operative to set a new previous minimum value equal to the lesser of said current minimum values.

13. A system according to claim 1 wherein said synchronization control apparatus is operative upon said playback queue becoming empty and said record queue being non-empty to erase at least one of said audio input units from said record queue.

14. A system according to claim 13 wherein said synchronization control apparatus erases all of said audio input units from said record queue.

15. A system according to claim 13 wherein said synchronization control apparatus erases provided said playback queue is empty on a plurality of occasions.

16. A system according to claim 13 wherein said synchronization control apparatus erases provided said playback queue is empty for a predefined period of time.

17. A method of acoustic echo cancellation comprising:
receiving at least one audio input unit at a record queue;
receiving at least one audio output unit at a playback queue;
retrieving said audio input unit from said record queue and said audio output unit from said playback queue, and
simultaneously providing said retrieved units to an acoustic echo canceller for acoustic echo cancellation thereat.

18. A method according to claim 17 wherein said simultaneously providing step comprises simultaneously providing in response to said playback queue receiving said audio output unit.

19. A method according to claim 17 wherein said simultaneously providing step comprises simultaneously providing in response to said playback queue receiving said audio output unit provided said record queue is non-empty.

20. A method according to claim 17 and further comprising:
incrementing an audio output unit counter in response to said playback queue receiving said audio output unit; and
decrementing said audio output unit counter when said audio output unit is retrieved from said playback queue.

21. A method according to claim 20 and further comprising:
comparing, upon said record queue becoming empty, the current minimum value of said counter with at least one previous minimum value of said counter when said record queue previously became empty; and
erasing, if said current minimum value is greater than said previous minimum value, at least one of said audio output units from said playback queue.

22. A method according to claim 21 wherein said erasing step comprises erasing a number of said audio output units from said playback queue not exceeding the difference between said current minimum value and said previous minimum value.

23. A method according to claim 21 and further comprising decrementing said counter by the number of said audio output units erased from said playback queue.

24. A method according to claim 21 and further comprising setting a new previous minimum value equal to said current minimum value.

25. A method according to claim 20 wherein said synchronization control apparatus is additionally operative upon said record queue becoming empty to:
comparing, upon said record queue becoming empty, a series of current minimum values of said counter with at least one previous minimum value of said counter when said record queue previously became empty; and
erasing, if each of said current minimum value is greater than said previous minimum value, at least one of said audio output units from said playback queue.

26. A method according to claim 25 wherein said erasing step comprises erasing a number of said audio output units from said playback queue not exceeding the difference between the lesser of said current minimum values and said previous number value.

27. A method according to claim 25 and further comprising decrementing said counter by the number of said audio output units erased from said playback queue.

28. A method according to claim 25 and further comprising setting a new previous minimum value equal to the lesser of said current minimum values.

29. A method according to claim 17 and further comprising erasing at least one of said audio input units from said record queue upon said playback queue becoming empty and said record queue being non-empty.

30. A method according to claim 29 wherein said erasing step comprises erasing all of said audio input units form said record queue.

31. A method according to claim 29 wherein said erasing step comprises erasing provided said playback queue is empty on a plurality of occasions.

32. A method according to claim 29 wherein said erasing step comprises erasing provided said playback queue is empty for a predefined period of time.

33. A method according to claim 17 and further comprising:
the first instance where at least one audio input unit is detected in said record queue and at least one audio output unit is detected in said playback queue, if there is a difference between the number of said units in each of said queues, removing at least one of said units from either of said queues until both of said queues have the same number of said units.

34. A method according to claim 33 wherein said removing step comprises removing if the difference between the number of said units in each of said queues exceeds a predefined threshold.

35. A method according to claim 17 and further comprising:
at the first instance where at least one audio input unit is detected in said record queue and at least one audio output unit is detected in said playback queue, if there is a difference between the number of said units in each of said queues, removing at least one of said units from either of said queues until the difference between the number of said units in each of said queues does not exceed a predefined threshold.

36. A method according to claim 35 wherein said removing step comprises removing if the difference between the number of said units in each of said queues exceeds a predefined threshold.

37. A system according to claim 1 wherein said synchronization control apparatus is operative to perform said retrieval and said simultaneous provision in response to said record queue receiving said audio input unit.

38. A system according to claim 1 wherein said synchronization control apparatus is operative to perform said retrieval and said simultaneous provision in response to said record queue receiving said audio input unit provided said playback queue is non-empty.

39. A system according to claim 1 and further comprising:
an audio input unit counter,
and wherein said synchronization control apparatus is additionally operative in response to said record queue receiving said audio input unit to:
increment said audio input unit counter, and
decrement said audio input unit counter when said audio input unit is retrieved from said record queue.

40. A system according to claim 39 wherein said synchronization control apparatus is additionally operative upon said playback queue becoming empty to:
compare the current minimum value of said counter with at least one previous minimum value of said counter when said playback queue previously became empty, and
if said current minimum value is greater than said previous minimum value erase at least one of said audio input units from said record queue.

41. A system according to claim 40 wherein said synchronization control apparatus erases a number of said audio input units from said record queue not exceeding the difference between said current minimum value and said previous minimum value.

42. A system according to claim 40 wherein said synchronization control apparatus is operative to decrement said counter by the number of said audio input units erased from said record queue.

43. A system according to claim 40 wherein said synchronization control apparatus is operative to set a new previous minimum value equal to said current minimum value.

44. A system according to claim 39 wherein said synchronization control apparatus is additionally operative upon said playback queue becoming empty to:
compare a series of current minimum values of said counter with at least one previous minimum value of said counter when said playback queue previously became empty, and
if each of said current minimum values is greater than said previous minimum value, erase at least one of said audio input units from said record queue.

45. A system according to claim 44 wherein said synchronization control apparatus erases a number of said audio input units from said record queue not exceeding the difference between the lesser of said current minimum values and said previous minimum value.

46. A system according to claim 44 wherein said synchronization control apparatus is operative to decrement said counter by the number of said audio input units erased from said record queue.

47. A system according to claim 44 wherein said synchronization control apparatus is operative to set a new previous minimum value equal to the lesser of said current minimum values.

48. A system according to claim 1 wherein said synchronization control apparatus is operative upon said record queue becoming empty and said playback queue being non-empty to erase at least one of said audio output units from said playback queue.

49. A system according to claim 48 wherein said synchronization control apparatus erases all of said audio output units from said playback queue.

50. A system according to claim 48 wherein said synchronization control apparatus erases provided said record queue is empty on a plurality of occasions.

51. A system according to claim 48 wherein said synchronization control apparatus erases provided said record queue is empty for a predefined period of time.

52. A method according to clam 17 wherein said simultaneously providing step comprises simultaneously providing in response to said record queue receiving said audio input unit.

53. A method according to claim 17 wherein said simultaneously providing step comprises simultaneously providing in response to said record queue receiving said audio input unit provided said playback queue is non-empty.

54. A method according to claim 17 and further comprising:
incrementing an audio input unit counter in response to said record queue receiving said audio input unit; and
decrementing said audio input unit counter when said audio input unit is retrieved from said record queue.

55. A method according to claim 54 and further comprising:
comparing, upon said playback queue becoming empty, the current minimum value of said counter with at least one previous minimum value of said counter when said playback queue previously became empty; and
erasing, if said current minimum value is greater than said previous minimum value, at least one of said audio input units from said record queue.

56. A method according to claim 55 wherein said erasing step comprises erasing number of said audio input units from said record queue not exceeding the difference between said current minimum value and said previous minimum value.

57. A method according to claim 55 and further comprising decrementing said counter by the number of said audio input units erased from said record queue.

58. A method according to claim 55 and further comprising setting a new previous minimum value equal to said current minimum value.

59. A method according to claim 54 wherein said synchronization control apparatus is additionally operative upon said playback queue becoming empty to:
comparing, upon said playback queue becoming empty, a series of current minimum values of said counter with at least one previous minimum value of said counter when said playback queue previously became empty; and
erasing, if each of said current minimum value is greater than said previous minimum value, at least one of said audio input units from said record queue.

60. A method according to claim 59 wherein said erasing step comprises erasing a number of said audio input units from said record queue not exceeding the difference between the lesser of said current minimum values and said previous minimum value.

61. A method according to claim 59 and further comprising decrementing said counter by the number of said audio input units erased from said record queue.

62. A method according to claim 59 and further comprising setting a new previous minimum value equal to the lesser of said current minimum values.

63. A method according to claim 17 and further comprising erasing at least one of said audio output units from said playback queue upon said record queue becoming empty and said playback queue being non-empty.

64. A method according to claim 63 wherein said erasing step comprises erasing all of said audio output units from said playback queue.

65. A method according to claim 63 wherein said erasing step comprises erasing provided said record queue is empty on a plurality of occasions.

66. A method according to claim 63 wherein said erasing step comprises erasing provided said record queue is empty for a predefined period of time.

67. A method according to claim 17 and further comprising:
at the first instance where at least one audio output unit is detected in said playback queue and at least one audio input unit is detected in said record queue, if there is a difference between the number of said units in each of said queues, removing at least one of said units from either of said queues until both of said queues have the same number of said units.

68. A method according to claim 67 wherein said removing step comprises removing if the difference between the number of said units in each of said queues exceeds a predefined threshold.

69. A method according to claim 17 and further comprising:
at the first instance where at least one audio output unit is detected in said playback queue and at least one audio input unit is detected in said record queue, if there is a difference between the number of said units in each of said queues, removing at least one of said units from either of said queues until the difference between the number of said units in each of said queues does not exceed a predefined threshold.

70. A method according to claim 69 wherein said removing step comprises removing if the difference between the number of said units in each of said queues exceeds a predefined threshold.
